(19) United States
(12) Patent Application Publication
(10) Pub. No.: US 2026/0304158 A1
(43) Pub. Date: Oct. 1, 2026

(54) METHOD AND WIRELESS DEVICE FOR ADAPTIVE OPERATION MODE SWITCHING IN MULTI-LINK WIRELESS COMMUNICATION

(71) Applicant: MEDIATEK INC., Hsinchu City (TW)

(72) Inventors: Yu-Yang Lin, Hsinchu City (TW); Chih-Chia Chou, Hsinchu City (TW)

(73) Assignee: MEDIATEK INC., Hsinchu City (TW)

(21) Appl. No.: 19/575,896

(22) Filed: Mar. 23, 2026

Related U.S. Application Data
(60) Provisional application No. 63/781,984, filed on Apr. 1, 2025.

(51) Int. Cl. H04W 24/02; H04W 24/08

(52) U.S. Cl. CPC H04W 24/02; H04W 24/08

(57) ABSTRACT

Methods and wireless devices for adaptive operation mode switching in multi-link wireless communication are disclosed. A wireless device operates in a first operation mode on a first link of multiple wireless links and monitors an interference level on the first link. When the interference level exceeds a threshold, the wireless device switches to a second operation mode and monitors the multiple wireless links. While operating in the second operation mode, the wireless device estimates a first performance metric for the first operation mode and a second performance metric for the second operation mode based on information collected from the multiple wireless links. Based on a comparison of the performance metrics, the wireless device determines whether to maintain the second operation mode or switch back to the first operation mode. The wireless device periodically re-estimates the performance metrics based on updated interference information to adapt to changing conditions.

### CROSS REFERENCE TO RELATED APPLICATIONS

This application claims the benefit of U.S. Provisional Application No. 63/781,984, filed on Apr. 1, 2025. The content of the application is incorporated herein by reference.

### BACKGROUND

Wireless local area networks (WLANs), including Wi-Fi® networks compliant with the IEEE 802.11 family of standards, have evolved to support multi-link operation (MLO), which enables a wireless device to establish connections across multiple frequency bands. Among the MLO modes, multi-link single radio (MLSR) and enhanced multi-link single radio (EMLSR) represent two operation modes that may be adopted based on hardware configuration and performance considerations. In MLSR operation, a device may perform data transmission and reception on a single link while maintaining connections on additional links. In EMLSR operation, a device may monitor multiple links for transmission opportunities, though switching radio-frequency resources between links may introduce a transition overhead.

In some deployment scenarios, interference from overlapping basic service sets (OBSS), Bluetooth signals, or other sources may occupy a portion of the available channel time on a given link. When such interference reduces the available air time on a link used for MLSR operation, the throughput on that link may degrade in proportion to the interference occupancy. For instance, if interference occupies approximately two-thirds of the available air time, the achievable throughput on that link may be reduced by a corresponding proportion. However, the mode selected at the time of connection setup may remain fixed regardless of changes in interference conditions, and the device may lack a mechanism to evaluate whether an alternative operation mode would yield higher throughput under the current interference environment.

### SUMMARY

An embodiment of the present disclosure provides a method for wireless communication. The method is performed by a first wireless device. The first wireless device operates in a first operation mode on a first link of a plurality of wireless links associated with the first wireless device and a second wireless device. The first wireless device monitors an interference level on the first link while operating in the first operation mode. In response to the interference level exceeding a threshold, the first wireless device switches from the first operation mode to a second operation mode. The first wireless device monitors the plurality of wireless links while operating in the second operation mode. While operating in the second operation mode, the first wireless device estimates a first performance metric for the first operation mode and a second performance metric for the second operation mode based on information collected from the plurality of wireless links. Based on a comparison of the first performance metric and the second performance metric, the first wireless device determines whether to maintain the second operation mode or to switch to the first operation mode.

Another embodiment of the present disclosure provides a wireless device. The wireless device comprises a plurality of antennas, a transceiver, one or more processors, and a memory. The transceiver is coupled to the plurality of antennas and configured to communicate with a second wireless device over a plurality of wireless links. The one or more processors are coupled to the transceiver. The memory is coupled to the one or more processors and stores instructions. When executed by the one or more processors, the instructions cause the wireless device to perform the following operations. The wireless device operates in a first operation mode on a first link of the plurality of wireless links. The wireless device monitors, via the transceiver, an interference level on the first link while operating in the first operation mode. In response to the interference level exceeding a threshold, the wireless device switches from the first operation mode to a second operation mode. The wireless device monitors, via the transceiver, the plurality of wireless links while operating in the second operation mode. While operating in the second operation mode, the wireless device estimates a first performance metric for the first operation mode and a second performance metric for the second operation mode based on information collected from the plurality of wireless links. Based on a comparison of the first performance metric and the second performance metric, the wireless device determines whether to maintain the second operation mode or to switch to the first operation mode.

These and other objectives of the present disclosure will become apparent to those of ordinary skill in the art after reading the following detailed description of embodiments illustrated in the various figures and drawings.

### BRIEF DESCRIPTION OF THE DRAWINGS

FIG. 1 is a block diagram of a wireless communication system including two wireless devices according to an embodiment of the present disclosure.

FIG. 2 is a state diagram m illustrating operation mode transitions of a wireless device according to an embodiment of the present disclosure.

FIG. 3 is a sequence diagram illustrating a process of switching from a first operation mode to a second operation mode according to an embodiment of the present disclosure.

FIG. 4 is a sequence diagram illustrating a process of evaluating operation mode performance while operating in the second operation mode according to an embodiment of the present disclosure.

### DETAILED DESCRIPTION

The following detailed description refers to the accompanying drawings, which illustrate specific embodiments by way of example. These embodiments are described in sufficient detail to enable those skilled in the art to practice the disclosed subject matter. Other embodiments may be utilized, and structural, logical, or electrical changes may be made without departing from the scope of the appended claims. Features from different embodiments may be combined freely, and terms such as “comprising” are open-ended unless context indicates otherwise. The detailed description is therefore not to be taken in a limiting sense.

As used herein, the term “multi-link operation” or “MLO” refers to a feature defined by the IEEE 802.11be standard that allows a wireless device to establish and use multiple wireless links for concurrent data transmission and reception with another wireless device. Each link operates on a respective frequency band or channel.

As used herein, the term “interference ratio” refers to a ratio of time during which a wireless link is occupied by interference to a total observation period. The interference ratio indicates the degree to which interference reduces the available air time on the link.

As used herein, the term “available air time ratio” refers to the fraction of a total observation period during which a wireless link is not occupied by interference. The available air time ratio for a given link is equal to one minus the interference ratio measured on that link.

As used herein, the term “switching overhead factor” refers to a multiplicative factor applied to an estimated throughput to account for the time delay incurred when a wireless device switches its radio-frequency (RF) chains from one link to another. The switching overhead factor has a value in the range of greater than 0 to 1, where a value closer to 1 indicates a shorter switching delay.

As used herein, the term “link access probability” refers to a probability that a wireless device, when monitoring multiple links, accesses a given link for data exchange. In certain embodiments, the link access probability for a given link is proportional to the available air time ratio of that link relative to the total available air time across all monitored links.

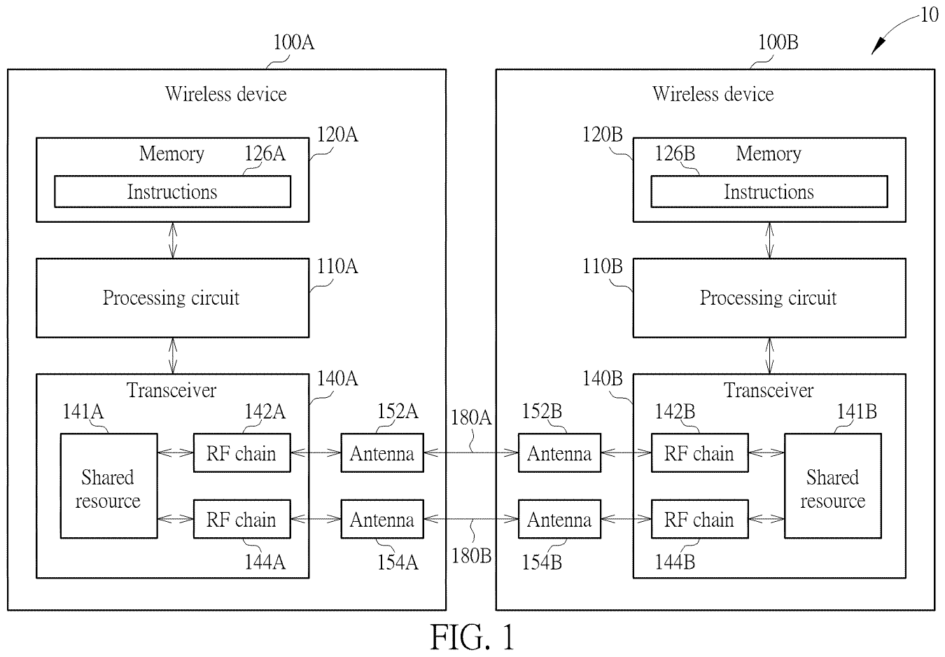

FIG. 1 is a block diagram of a wireless communication system 10 including two wireless devices 100A and 100B according to an embodiment of the present disclosure. The wireless device 100A and the wireless device 100B are configured to support multi-link operation (MLO) and to operate in one of a multi-link single radio (MLSR) mode and an enhanced multi-link single radio (EMLSR) mode. In certain embodiments, the wireless device 100A may operate as a non-access-point station (non-AP STA) and the wireless device 100B may operate as an access point (AP). In other embodiments, both the wireless device 100A and the wireless device 100B may operate as non-AP STAs that communicate over a plurality of wireless links established through multi-link operation.

The wireless device 100A includes a processing circuit 110A, a memory 120A, and a transceiver 140A. The wireless device 100B includes a processing circuit 110B, a memory 120B, and a transceiver 140B. The transceiver 140A includes a shared resource 141A and a plurality of RF chains, including an RF chain 142A and an RF chain 144A. The RF chain 142A and the RF chain 144A are coupled to antennas 152A and 154A, respectively. Correspondingly, the transceiver 140B includes a shared resource 141B, an RF chain 142B, and an RF chain 144B coupled to antennas 152B and 154B, respectively.

The processing circuit 110A comprises one or more processors and may be implemented as one or more microprocessors, microcontrollers, application specific integrated circuits (ASICS), field programmable gate arrays (FPGAs), or digital signal processors (DSPs). The processing circuit 110A is coupled to the transceiver 140A and is configured to execute control logic for IEEE 802.11be operation, including logic for monitoring interference on wireless links, estimating throughput for different operation modes, and controlling transitions between the MLSR mode and the EMLSR mode. The memory 120A is coupled to the processing circuit 110A and may include volatile memory (e.g., DRAM, SRAM) and non-volatile memory (e.g., Flash, EEPROM) for storing data and program code. The memory 120A stores instructions 126A, and the memory 120B stores instructions 126B. The instructions 126A comprise computer-executable code that, when executed by the processing circuit 110A, causes the wireless device 100A to perform the methods described herein, including monitoring interference levels on wireless links, estimating performance metrics for the MLSR mode and the EMLSR mode, and determining whether to switch between operation modes based on a comparison of the estimated performance metrics. The instructions 126B comprise computer-executable code that, when executed by the processing circuit 110B, causes the wireless device 100B to perform the methods described herein.

Each RF chain may include hardware for signal processing, such as power amplifiers, low-noise amplifiers, mixers, and analog-to-digital or digital-to-analog converters. The shared resource 141A is shared by the RF chain 142A and the RF chain 144A, and the shared resource 141B is shared by the RF chain 142B and the RF chain 144B. The shared resource 141A or 141B may comprise at least one of (i) a shared baseband circuit (e.g., a baseband processor, modem, or digital front-end) configured to generate, process, and schedule baseband signals for the plurality of RF chains, or (ii) a shared oscillator (e.g., a reference clock, local oscillator (LO), frequency synthesizer, or phase-locked loop (PLL)) configured to provide a common frequency reference and tuning control to the RF chains. The shared resource 141A or 141B may be implemented as a discrete component within the transceiver, or may be distributed across multiple components of the transceiver, such as a shared RFIC or baseband chipset.

As used herein, a “wireless link” refers to a communication channel established between two wireless devices on a particular frequency band. Each wireless link is associated with a respective frequency band and carries signals for data transmission, reception, and management frame exchange between the wireless device 100A and the wireless device 100B. In the context of the present disclosure, a “single radio” device, such as the wireless device 100A or the wireless device 100B, is a device that has multiple radio-frequency (RF) chains and that shares, via the shared resource 141A or 141B, a common baseband or local oscillator resource. Such sharing causes the plurality of RF chains to be applied on one selected frequency band at a time rather than independently applied on two widely separated frequency bands simultaneously for transmission or reception. When the plurality of RF chains are directed to operate on a same frequency band on a target link, the shared resource 141A or 141B constrains or coordinates the RF chains such that at least two antennas transmit or receive wireless signals on the target link on that same frequency band (e.g., the same channel and band).

As illustrated FIG. 1, the wireless device 100A communicates with the wireless device 100B over a first link 180A and a second link 180B. The first link 180A is a wireless link on a first frequency band (e.g., a 5 GHz band), and the second link 180B is a wireless link on a second frequency band (e.g., a 6 GHZ band). In some embodiments, the wireless device 100A and the wireless device 100B may establish three or more wireless links on different frequency bands, such as the 2.4 GHZ, 5 GHZ, and 6 GHz bands.

When the wireless device 100A operates in the MLSR mode, the wireless device 100A selects one link of the plurality of wireless links and performs data transmission and reception on the selected link using the plurality of RF chains on a same frequency band of the selected link. At connection setup, the wireless device 100A may select the operating link for the MLSR mode based on estimated throughput of each link evaluated under an assumption that no interference is present. For example, when operating in the MLSR mode on the first link 180A, both the antenna 152A and the antenna 154A transmit and receive on the first link 180A. The second link 180B remains established but is not actively used for data exchange. Because no switching between links occurs during the MLSR mode, the wireless device 100A avoids the time overhead associated with antenna switching and may achieve higher throughput when the selected link experiences low interference.

When the wireless device 100A operates in the EMLSR mode, the wireless device 100A monitors at least the first link 180A and the second link 180B for transmission opportunities. In certain embodiments, the transceiver 140A allocates the RF chain 142A coupled to the antenna 152A to monitor the first link 180A, and allocates the RF chain 144A coupled to the antenna 154A to monitor the second link 180B. The wireless device 100A receives management frames, including beacon frames, on each monitored link while operating in the EMLSR mode. Upon detection of a transmission opportunity on a target link, the wireless device 100A dynamically switches its plurality of RF chains to the target link to perform data transmission and reception on a same frequency band of the target link. This switching takes time and introduces a switching overhead that may reduce the effective throughput relative to what would be achievable without the switching delay.

In some embodiments, the wireless device 100A and the wireless device 100B are not limited to the two-antenna example shown in FIG. 1. The depiction of two antennas (e.g., antennas 152A and 154A, and antennas 152B and 154B) and two RF chains (e.g., RF chains 142A and 144A, and RF chains 142B and 144B) is illustrative and is not limiting. For example, the wireless device 100A may include three or more antennas and the transceiver 140A may include three or more RF chains coupled to the respective antennas. In such implementations, the plurality of antennas and the plurality of RF chains operate together on a same frequency band on the target link. The communication between the wireless device 100A and the wireless device 100B is also not limited to two links. For example, the wireless device 100A and the wireless device 100B may establish and operate over three or more wireless links, each on a respective frequency band (e.g., 2.4 GHZ, 5 GHz, and 6 GHz bands). In such embodiments, the wireless device 100A operating in the EMLSR mode may select a subset of the established links (e.g., two links) for monitoring and may switch its RF chains to whichever monitored link has a transmission opportunity.

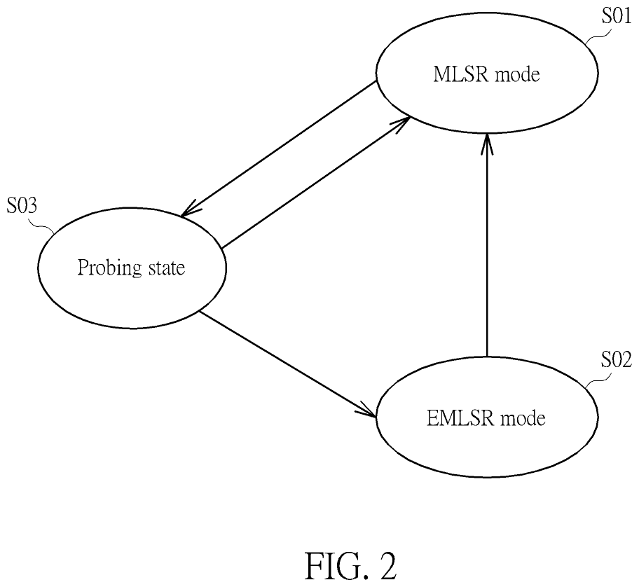

FIG. 2 illustrates a state diagram showing operation mode transitions of a wireless device according to an embodiment of the present disclosure. The state diagram of FIG. 2 may be implemented by the wireless device 100A, under control of the processing circuit 110A. FIG. 2 depicts three states: an MLSR mode S01, an EMLSR mode S02, and a probing state S03. The transitions between the three states are asymmetric. To transition from the MLSR mode S01 to the EMLSR mode S02, the wireless device 100A first determines, while operating in the MLSR mode S01, that an interference level on the operating link exceeds a threshold, and then enters the probing state S03 to evaluate whether the EMLSR mode S02 would provide better performance. The wireless device 100A transitions to the EMLSR mode S02 only after the evaluation in the probing state S03 confirms a performance benefit. In contrast, to transition from the EMLSR mode S02 to the MLSR mode S01, the wireless device 100A does not enter the probing state S03. Instead, the wireless device 100A performs periodic performance re-evaluation while operating in the EMLSR mode S02 and transitions directly to the MLSR mode S01 when the re-evaluation indicates that the MLSR mode S01 would provide better performance.

In the embodiment of FIG. 2, the MLSR mode S01 corresponds to the first operation mode. In the MLSR mode S01, the wireless device 100A performs data transmission and reception on a first link 180A of a plurality of wireless links using the plurality of RF chains 142A and 144A on a same frequency band of the first link 180A. The first link 180A is the link that the wireless device 100A selected at connection setup under the assumption of no interference, as described with reference to FIG. 1. Because all data transmission and reception is performed on the first link 180A, interference on the first link 180A affects the entirety of the data exchange between the wireless device 100A and the wireless device 100B. While operating in the MLSR mode S01, the wireless device 100A monitors an interference level on the first link 180A. The interference level may be characterized as a proportion of time during which the first link 180A is occupied by interference relative to an observation period. In certain embodiments, the monitoring is performed continuously or at regular intervals. When the monitored interference level exceeds a threshold (e.g., a predetermined interference threshold), the wireless device 100A transitions from the MLSR mode S01 to the probing state S03 to begin a performance evaluation process. If interference remains below the threshold, the wireless device 100A stays in the MLSR mode S01 without evaluating mode switching.

The probing state S03 is a transitional state in which the wireless device 100A evaluates relative performance between the MLSR mode and the EMLSR mode. In the probing state S03, the wireless device 100A switches to monitoring the plurality of wireless links and collects interference information from each monitored link. Based on the collected information, the processing circuit 110A estimates a first performance metric for the MLSR mode S01 (e.g., an estimated throughput for the MLSR mode) and a second performance metric for the EMLSR mode S02 (e.g., an estimated throughput for the EMLSR mode), and compares the two performance metrics. The second performance metric accounts for a switching overhead associated with the EMLSR mode. The switching overhead is caused by the time delay that occurs when the wireless device 100A switches the plurality of RF chains 142A and 144A from one link to another. During this switching, the shared resource 141A (e.g., the shared baseband circuit or the shared oscillator) retunes from the frequency band of the source link to the frequency band of the target link, and the antennas 152A and 154A are reconfigured accordingly. While the retuning is in progress, the wireless device 100A cannot transmit or receive data on any link, and this idle period reduces the effective throughput of the EMLSR mode relative to what would be achievable without the switching delay.

From the probing state S03, the wireless device 100A transitions to one of two states depending on the comparison result. If the second performance metric is greater than or equal to the first performance metric, the wireless device 100A transitions from the probing state S03 to the EMLSR mode S02, indicating that the EMLSR mode is estimated to achieve equal or higher throughput than the MLSR mode even after accounting for the switching overhead. Conversely, if the second performance metric is less than the first performance metric, the wireless device 100A transitions from the probing state S03 back to the MLSR mode S01, indicating that the throughput gain from the EMLSR mode is not sufficient to offset the switching overhead. In this way, the probing state S03 allows the wireless device 100A to verify the performance benefit before entering the EMLSR mode S02.

In the embodiment of FIG. 2, the EMLSR mode S02 corresponds to the second operation mode. In the EMLSR mode S02, the wireless device 100A monitors at least the first link 180A and the second link 180B of the plurality of wireless links for transmission opportunities. When a transmission opportunity is detected on a target link, the wireless device 100A switches the plurality of RF chains 142A and 144A to the target link to perform data transmission and reception on a same frequency band of the target link. By using transmission opportunities on the plurality of wireless links, the wireless device 100A can distribute data transmission across the first link 180A and the second link 180B. When interference occupies a portion of the available air time on the first link 180A, the wireless device 100A can use transmission opportunities on the second link 180B to continue data exchange, thereby reducing the impact of the interference on overall throughput.

While operating in the EMLSR mode S02, the wireless device 100A monitors the plurality of wireless links and continuously collects interference information from all monitored links. Using this information, the wireless device 100A periodically re-estimates the first performance metric and the second performance metric, and re-determines whether to maintain the EMLSR mode S02 or to switch to the MLSR mode S01. If the re-estimated second performance metric remains greater than or equal to the re-estimated first performance metric, the wireless device 100A continues operating in the EMLSR mode S02. If the re-estimated second performance metric falls below the re-estimated first performance metric, the wireless device 100A transitions directly to the MLSR mode S01, returning to single-link operation on the first link 180A. Unlike the transition from the MLSR mode S01, the probing state S03 is not required in this direction because the wireless device 100A in the EMLSR mode S02 already has the interference information for all monitored links. In some embodiments, the periodic re-evaluation may be triggered by a timer that expires at configurable intervals.

The state diagram of FIG. 2 thus provides an adaptive switching mechanism that forms a closed loop. The wireless device 100A does not remain in a fixed operation mode selected at connection setup. Instead, the wireless device 100A monitors interference on an ongoing basis, evaluates performance when interference increases beyond the threshold, and switches between the MLSR mode S01 and the EMLSR mode S02 as interference conditions change over time.

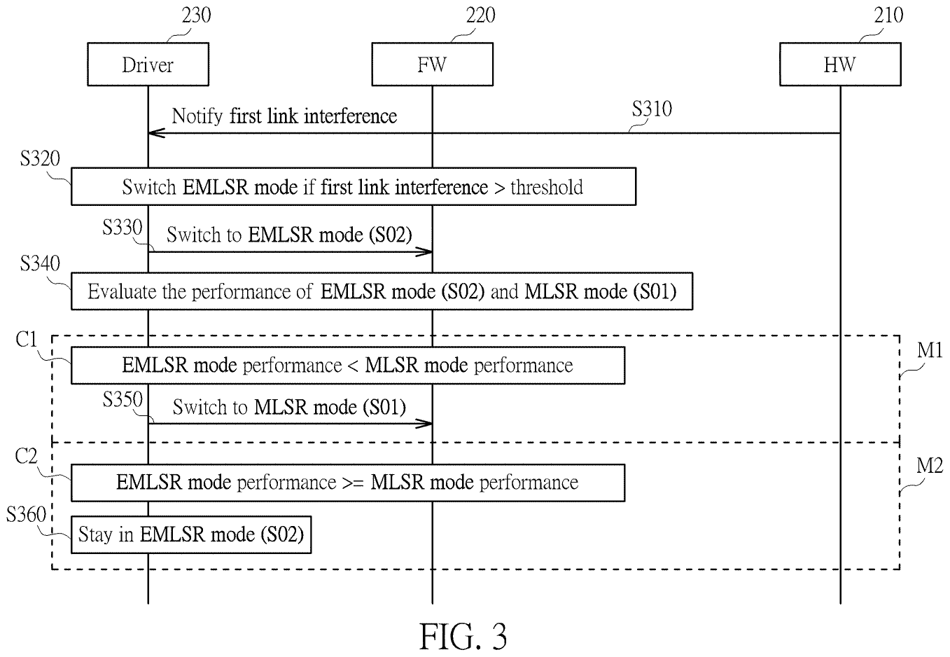

FIG. 3 illustrates a sequence diagram showing a process of switching from the first operation mode (e.g., the MLSR mode S01) to the second operation mode (e.g., the EMLSR mode S02) according to an embodiment of the present disclosure. The process of FIG. 3 may be performed by the wireless device 100A and corresponds to the transition from the MLSR mode S01 through the probing state S03 to the EMLSR mode S02 or back to the MLSR mode S01 as described with reference to FIG. 2. FIG. 3 depicts interactions among three processing layers within the wireless device 100A: a hardware layer (HW) 210, a firmware layer (FW) 220, and a driver layer 230. In certain embodiments, the hardware layer 210 corresponds to the transceiver 140A, the firmware layer 220 corresponds to firmware executed by the processing circuit 110A, and the driver layer 230 corresponds to the instructions 126A executed by the processing circuit 110A.

At step S310, the hardware layer 210 notifies the driver layer 230 of an interference condition on the first link 180A. While the wireless device 100A operates in the MLSR mode S01, the hardware layer 210 monitors the first link 180A and measures interference information associated with the first link 180A. In certain embodiments, the hardware layer 210 measures, over an observation period, a proportion of time during which the first link 180A is occupied by interference relative to the observation period to obtain an interference ratio. The interference ratio represents a reduction in available air time on the first link 180A: as interference increases, the proportion of time available for data transmission on the first link 180A decreases. The observation period may correspond to one or more beacon intervals. When the hardware layer 210 detects that the interference ratio has changed or exceeds a reporting condition, the hardware layer 210 sends an interference notification to the driver layer 230.

In certain embodiments, the interference measured by the hardware layer 210 may comprise at least one of overlapping basic service set (OBSS) interference, Bluetooth interference, or noise. OBSS interference arises when a neighboring access point operates a basic service set on the same channel or an overlapping channel as the first link 180A, causing contention for channel access time. Bluetooth interference arises from in-device coexistence between a Bluetooth radio and the Wi-Fi® radio sharing the same or adjacent frequency bands. Noise may include thermal noise, adjacent-channel interference, or other signal sources not conforming to the IEEE 802.11 standard that reduce signal quality on the first link 180A.

At step S320, which is performed while the wireless device 100A operates in the MLSR mode S01 of FIG. 2, the driver layer 230 compares the interference ratio received at step S310 against a threshold. If the interference ratio exceeds the threshold, the driver layer 230 determines that the interference on the first link 180A is sufficiently high to justify evaluating whether the second operation mode (e.g., the EMLSR mode) would provide better performance, and the wireless device 100A transitions from the MLSR mode S01 to the probing state S03 of FIG. 2. If the interference ratio does not exceed the threshold, the wireless device 100A remains in the MLSR mode S01 and continues monitoring the first link 180A.

The threshold is a predetermined interference threshold that may be configured based on implementation considerations. In one embodiment, the threshold is set to 0.3, meaning that when interference occupies more than 30 percent of the available air time on the first link 180A, the driver layer 230 initiates a mode transition evaluation. In other embodiments, the threshold may be set to a different value (e.g., 0.2 or 0.4) depending on the wireless environment and the characteristics of the wireless device 100A. In some embodiments, the threshold may be adjusted dynamically based on historical interference patterns observed by the driver layer 230.

At step S330, in response to the interference ratio exceeding the threshold at step S320, the driver layer 230 instructs the firmware layer 220 to switch the wireless device 100A from the MLSR mode to the EMLSR mode. In terms of the state diagram of FIG. 2, step S330 corresponds to the transition from the probing state S03 to the EMLSR mode S02. The firmware layer 220 configures the hardware layer 210 to begin monitoring at least the first link 180A and the second link 180B of the plurality of wireless links. In certain embodiments, this corresponds to configuring the transceiver 140A to split the plurality of RF chains 142A and 144A across the first link 180A and the second link 180B rather than aggregating all RF chains on the first link 180A. After entering the EMLSR mode S02, the wireless device 100A begins collecting interference information from the plurality of wireless links for periodic performance re-evaluation.

At step S340, which is performed while the wireless device 100A operates in the EMLSR mode S02 of FIG. 2, the driver layer 230 evaluates performance of the EMLSR mode S02 and the MLSR mode S01 by estimating a first performance metric for the first operation mode and a second performance metric for the second operation mode based on information collected from the plurality of wireless links. In certain embodiments, the first performance metric comprises an estimated throughput for the first operation mode, and the second performance metric comprises an estimated throughput for the second operation mode.

For each link of the plurality of wireless links, the hardware layer 210 measures an interference ratio over the observation period. Let OBSS₁ denote the interference ratio measured on the first link 180A and OBSS₂ denote the interference ratio measured on the second link 180B. An available air time ratio for each link is computed as one minus the interference ratio measured on the respective link. For the first link 180A, the available air time ratio equals (1−OBSS₁), representing the fraction of the observation period during which the first link 180A is not occupied by interference. For the second link 180B, the available air time ratio equals (1−OBSS₂).

The driver layer 230 determines an estimated physical layer data rate for each link of the plurality of wireless links. Let R₁ denote the estimated physical layer data rate of the first link 180A and R₂ denote the estimated physical layer data rate of the second link 180B.

In the wireless communication system 10, the wireless device 100B periodically transmits beacon frames on each established wireless link. The wireless device 100A receives these beacon frames on the first link 180A and the second link 180B via the transceiver 140A. In certain embodiments, the estimated physical layer data rate for a given link is determined based on a received signal strength indicator (RSSI) measured from beacon frames received on that link. For example, the hardware layer 210 measures an average RSSI from beacon frames received on the first link 180A and maps the measured RSSI to an estimated physical layer data rate R₁ using a modulation and coding scheme (MCS) index lookup table. The hardware layer 210 performs a corresponding measurement from beacon frames received on the second link 180B to obtain R₂.

The hardware layer 210 may obtain R₁ from beacon frames received on the first link 180A. Because the wireless device 100A monitors the first link 180A in both the MLSR mode S01 and the EMLSR mode S02, R₁ may be updated during either operation mode. The estimated physical layer data rate R₂ for the second link 180B may be obtained when the wireless device 100A monitors the second link 180B, such as during the probing state S03 or after switching to the EMLSR mode S02 at step S330. In some embodiments, the hardware layer 210 may use a default or preconfigured value for R₂ until an updated RSSI measurement from beacon frames on the second link 180B becomes available.

The estimated throughput for the first operation mode (e.g., the MLSR mode) is calculated as a product of the estimated physical layer data rate of the first link 180A and the available air time ratio of the first link 180A. Expressed as a formula:

$${MLSR}_{tput} = {R}_{1} \times ( 1 - {OBSS}_{1} )$$

where R₁ is the estimated physical layer data rate of the first link 180A and (1−OBSS₁) is the available air time ratio of the first link 180A. Because the wireless device 100A in the MLSR mode operates on only the first link 180A, the estimated throughput for the first operation mode reflects the data rate achievable on the first link 180A after accounting for the time consumed by interference. The operating link for the MLSR mode may have been initially selected at connection setup under an assumption of no interference. During the performance evaluation at step S340, however, the driver layer 230 accounts for the measured interference on each link. In some embodiments where the wireless device 100A may select either the first link 180A or the second link 180B for MLSR operation, the driver layer 230 may also compute (R₂×(1−OBSS₂)) and select the link with the higher estimated throughput as the baseline for comparison.

When operating in the EMLSR mode, the wireless device 100A monitors multiple links and accesses whichever link has a transmission opportunity. Because the links may have different levels of interference, the probability that the wireless device 100A accesses a given link depends on the relative amount of available air time across the monitored links. Let P₁ denote the link access probability for the first link 180A and P₂ denote the link access probability for the second link 180B. In certain embodiments, the link access probability for each link is determined as:

$${P}_{1} = \frac{( 1 - {OBSS}_{1} )}{( 1 - {OBSS}_{1} ) + ( 1 - {OBSS}_{2} )}$$

$${P}_{2} = \frac{( 1 - {OBSS}_{2} )}{( 1 - {OBSS}_{1} ) + ( 1 - {OBSS}_{2} )}$$

The link access probability P₁ represents the proportion of total available air time contributed by the first link 180A relative to the sum of available air time across all monitored links. A link that experiences less interference contributes a larger share of total available air time and thus has a higher access probability. For the case where the plurality of wireless links includes two links, P₁ and P₂ sum to one. In embodiments where the wireless device 100A monitors three or more links in the EMLSR mode, a link access probability Pᵢ for a given link i may be calculated as (1−OBSSᵢ) divided by the sum of (1−OBSSⱼ) across all monitored links j. Expressed as a formula:

$${P}_{i} = \frac{( 1 - {OBSS}_{i} )}{{\sum }_{j} ( 1 - {OBSS}_{j} )}$$

where P₁ is the link access probability for link i, OBSSᵢ is the interference ratio measured on link i, and the summation in the denominator is taken over all monitored links j.

When the wireless device 100A operates in the EMLSR mode, the wireless device 100A switches its plurality of RF chains to a target link upon detecting a transmission opportunity. This switching introduces a time delay during which the wireless device 100A cannot transmit or receive data. Let H denote a switching overhead factor that accounts for this delay. The switching overhead factor H is a value in the range of greater than 0 to 1, where a value closer to 1 indicates lower overhead and a value closer to 0 indicates higher overhead. In certain embodiments, the switching overhead factor H is determined based on hardware characteristics of the transceiver 140A, such as the time for the shared resource 141A to retune from one frequency band to another. For a wireless device with a faster switching capability, H may be closer to 1, while for a wireless device with a slower switching capability, H may be smaller.

The estimated throughput for the second operation mode (e.g., the EMLSR mode) is calculated based on per-link throughput contributions across the plurality of wireless links. For each link, a per-link throughput contribution is determined as a product of the link access probability, the estimated physical layer data rate, and the available air time ratio of the respective link. The per-link throughput contributions are summed to obtain a combined throughput. The switching overhead factor is then applied to the combined throughput. Expressed as a formula:

$${EMLSR}_{tput} = H \times [ {P}_{1} \times {R}_{1} \times ( 1 - {OBSS}_{1} ) + {P}_{2} \times {R}_{2} \times ( 1 - {OBSS}_{2} ) ]$$

where H is the switching overhead factor, P1 and P2 are the link access probabilities for the first link 180A and the second link 180B, R1 and R2 are the estimated physical layer data rates, and (1−OBSS₁) and (1−OBSS₂) are the available air time ratios. The term [P₁×Rᵢ×(1−OBSSᵢ)] represents the per-link throughput contribution for link i, indicating the throughput that the wireless device 100A can expect to achieve when it accesses that link. The sum of per-link throughput contributions represents the combined throughput across all monitored links. The switching overhead factor H scales the combined throughput to account for the time lost during RF chain switching, producing the estimated throughput for the second operation mode.

Substituting the link access probability expressions into the estimated throughput for the second operation mode yields an equivalent expanded form:

$${EMLSR}_{tput} = H \times [ \frac{{R}_{1} \times {( 1 - {OBSS}_{1} )}^{2}}{( 1 - {OBSS}_{1} ) + ( 1 - {OBSS}_{2} )} + \frac{{R}_{2} \times {( 1 - {OBSS}_{2} )}^{2}}{( 1 - {OBSS}_{1} ) + ( 1 - {OBSS}_{2} )} ]$$

where R₁ and R₂ are the estimated physical layer data rates, OBSS₁ and OBSS₂ are the interference ratios measured on the first link 180A and the second link 180B, H is the switching overhead factor, and the denominator [(1−OBSS₁)+(1−OBSS₂)] represents the total available air time across the monitored links. This expanded form is mathematically equivalent to the factored form above and may be used in implementations where the driver layer 230 computes the throughput estimate without explicitly calculating the intermediate values of the link access probabilities P₁ and P₂.

In some embodiments, simplified versions of the estimated throughput for the second operation mode may be used. In a first alternative, the driver layer 230 computes the estimated throughput without the link access probability and the switching overhead factor. Let EMLSR_{tput_alt1} denote the estimated throughput for the second operation mode under this first alternative. The estimated throughput EMLSR_{tput_alt1} is calculated as:

$${EMLSR}_{{tput}_{alt 1}} = {R}_{1} \times ( 1 - {OBSS}_{1} ) + {R}_{2} \times ( 1 - {OBSS}_{2} )$$

where R₁ and R₂ are the estimated physical layer data rates of the first link 180A and the second link 180B, and (1−OBSS₁) and (1−OBSS₂) are the available air time ratios of the first link 180A and the second link 180B. This alternative omits the link access probability and the switching overhead factor, providing a simplified estimate that may be used when these parameters are not available or when reduced computational complexity is desired.

In a second alternative, the driver layer 230 includes the link access probability but omits the switching overhead factor. Let EMLSR_{tput_alt2} denote the estimated throughput for the second operation mode under this second alternative. The estimated throughput EMLSR_{tput_alt2} is calculated as:

$${EMLSR}_{{tput}_{alt 2}} = {P}_{1} \times {R}_{1} \times ( 1 - {OBSS}_{1} ) + {P}_{2} \times {R}_{2} \times ( 1 - {OBSS}_{2} )$$

where P₁ and P₂ are the link access probabilities, R₁ and R₂ are the estimated physical layer data rates, and (1−OBSS₁) and (1−OBSS₂) are the available air time ratios. This alternative accounts for the unequal likelihood of accessing each link but does not discount for the time lost during RF chain switching.

The formula including the switching overhead factor H (EMLSRₜₚᵤₜ above) provides a more precise estimate because it accounts for the time cost of RF chain switching, which may be significant relative to the duration of a transmission opportunity. The driver layer 230 may select among these formula variants based on the availability of measured parameters and the desired estimation precision.

After evaluating performance at step S340, the driver layer 230 compares the estimated throughput for the second operation mode (EMLSRₜₚᵤₜ) against the estimated throughput for the first operation mode (MLSRₜₚᵤₜ). Under condition C1, which is evaluated while the wireless device 100A operates in the EMLSR mode S02 of FIG. 2, the estimated throughput for the second operation mode is less than the estimated throughput for the first operation mode (EMLSRₜₚᵤₜ<MLSRₜₚᵤₜ). In scenario M1, in response to condition C1, the driver layer 230 determines to switch to the first operation mode. At step S350, the driver layer 230 instructs the firmware layer 220 to switch the wireless device 100A from the EMLSR mode S02 back to the MLSR mode S01. In terms of the state diagram of FIG. 2, step S350 corresponds to the transition from the EMLSR mode S02 to the MLSR mode S01. The firmware layer 220 configures the hardware layer 210 to direct the plurality of RF chains 142A and 144A to operate on a same frequency band on the first link 180A.

Condition C1 may arise, for example, when the interference on the second link 180B is also high, such that the benefit of monitoring multiple links does not compensate for the switching overhead represented by H. In such a case, returning to the MLSR mode S01 on the first link 180A avoids the switching overhead and provides higher estimated throughput than continuing to operate in the EMLSR mode S02.

Under condition C2, which is also evaluated while the wireless device 100A operates in the EMLSR mode S02 of FIG. 2, the estimated throughput for the second operation mode is greater than or equal to the estimated throughput for the first operation mode (EMLSRₜₚᵤₜ>=MLSRₜₚᵤₜ). In scenario M2, in response to condition C2, the driver layer 230 determines to maintain the second operation mode. At step S360, the wireless device 100A remains in the EMLSR mode S02. In terms of the state diagram of FIG. 2, step S360 corresponds to the self-loop at the EMLSR mode S02. The wireless device 100A then continues operating in the EMLSR mode S02, monitoring the plurality of wireless links for transmission opportunities and periodically re-evaluating the performance metrics.

The following numerical example illustrates the operation of the process of FIG. 3. Assume a two-link configuration where the first link 180A operates on a 5 GHz band and the second link 180B operates on a 6 GHz band. The hardware layer 210 measures the following parameters: an interference ratio OBSS₁=0.5 on the first link 180A (indicating that interference occupies 50 percent of the air time), an interference ratio OBSS₂=0.1 on the second link 180B, an estimated physical layer data rate R₁=200 Mbps on the first link 180A, and an estimated physical layer data rate R₂=300 Mbps on the second link 180B. The switching overhead factor H=0.9.

At step S310, while the wireless device 100A operates in the MLSR mode S01, the hardware layer 210 reports the interference ratio OBSS₁=0.5 to the driver layer 230. At step S320, the driver layer 230 compares OBSS₁=0.5 against the threshold of 0.3. Because 0.5 exceeds 0.3, the wireless device 100A enters the probing state S03 of FIG. 2, and the driver layer 230 initiates the transition from the probing state S03 to the EMLSR mode S02 at step S330. At step S340, the driver layer 230 computes the performance metrics as follows. The available air time ratios are (1−OBSS₁)=1−0.5=0.5 for the first link 180A and (1−OBSS₂)=1−0.1=0.9 for the second link 180B. The link access probabilities are P₁=0.5/(0.5+0.9)=0.357 for the first link 180A and P₂=0.9/(0.5+0.9)=0.643 for the second link 180B. The estimated throughput for the first operation mode is MLSRₜₚᵤₜ=200×0.5=100 Mbps. The estimated throughput for the second operation mode is EMLSRₜₚᵤₜ=0.9×[(0.357×200×0.5)+(0.643×300×0.9)]=0.9×[35.7+173.6]=0.9×209.3=188.4 Mbps. Because EMLSRₜₚᵤₜ (188.4 Mbps) is greater than MLSRₜₚᵤₜ (100 Mbps), condition C2 is satisfied, and the wireless device 100A stays in the EMLSR mode S02 at step S360.

As a contrasting example, consider a scenario where OBSS₂=0.6 on the second link 180B (both links heavily interfered) and H=0.7. The available air time ratios are (1−OBSS₁)=1−0.5=0.5 for the first link 180A and (1−OBSS₂)=1−0.6=0.4 for the second link 180B. The link access probabilities are P₁=0.5/(0.5+0.4)=0.556 for the first link 180A and P₂=0.4/(0.5+0.4)=0.444 for the second link 180B. The estimated throughput for the first operation mode is MLSRₜₚᵤₜ=200×0.5=100 Mbps. The estimated throughput for the second operation mode is EMLSRₜₚᵤₜ=0.7×[(0.556× 200×0.5)+(0.444×300×0.4)]=0.7×[55.6+53.3]=0.7×108.9=76.2 Mbps. Because EMLSRₜₚᵤₜ (76.2 Mbps) is less than MLSRₜₚᵤₜ (100 Mbps), condition C1 is satisfied, and the wireless device 100A switches back to the MLSR mode S01 at step S350. This example shows that when both links experience high interference and the switching overhead factor is low, the EMLSR mode may not provide a throughput benefit, and the wireless device 100A returns to single-link operation.

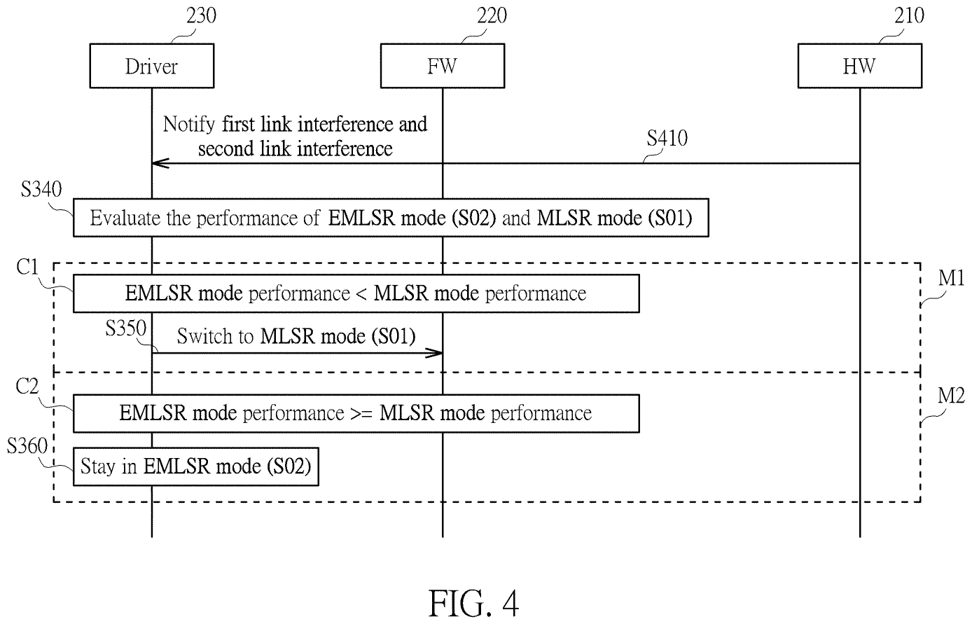

FIG. 4 illustrates a sequence diagram showing a process of periodically re-evaluating operation mode performance according to an embodiment of the present disclosure. The process of FIG. 4 assumes that the wireless device 100A is already operating in the EMLSR mode S02, and thus the wireless device 100A monitors the plurality of wireless links and has the interference information for all monitored links available without entering the probing state S03. Because the performance evaluation and mode determination in FIG. 4 follow the same procedures described with reference to steps S340, S350, and S360 of FIG. 3, the following description focuses on aspects specific to the periodic re-evaluation.

At step S410, the hardware layer 210 notifies the driver layer 230 of updated interference information for both the first link 180A and the second link 180B. In certain embodiments, the notification is sent periodically at configurable intervals. Upon receiving the updated interference information, the driver layer 230 performs the performance evaluation and mode determination as follows. At step S340, the driver layer 230 estimates the throughput for the first operation mode (MLSRₜₚᵤₜ) and the throughput for the second operation mode (EMLSRₜₚᵤₜ) based on the updated interference ratios and the estimated physical layer data rates, using the same formulas described with reference to FIG. 3. Under condition C1, if the estimated throughput for the second operation mode is less than the estimated throughput for the first operation mode (EMLSRₜₚᵤₜ<MMLSRₜₚᵤₜ), the driver layer 230 determines at step S350 to switch the wireless device 100A from the EMLSR mode S02 to the MLSR mode S01. Under condition C2, if the estimated throughput for the second operation mode is greater than or equal to the estimated throughput for the first operation mode (EMLSRₜₚᵤₜ>=MLSRₜₚᵤₜ), the driver layer 230 determines at step S360 to maintain the EMLSR mode S02. After step S360, the process of FIG. 4 repeats from step S410, forming the periodic re-evaluation loop described with reference to FIG. 2.

In summary, the present disclosure provides a method and a wireless device for adaptive operation mode switching in multi-link wireless communication. A first wireless device operates in a first operation mode on a first link of a plurality of wireless links and monitors an interference level on the first link. When the interference level exceeds a threshold, the first wireless device switches to a second operation mode and monitors the plurality of wireless links. The first wireless device estimates a first performance metric for the first operation mode and a second performance metric for the second operation mode based on information collected from the plurality of wireless links, and determines whether to maintain the second operation mode or to switch to the first operation mode based on a comparison of the two performance metrics. This approach allows the wireless device to select the operation mode that yields higher performance under current interference conditions rather than remaining in a fixed mode selected at connection setup.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method for wireless communication performed by a first wireless device, the method comprising:
operating in a first operation mode on a first link of a plurality of wireless links associated with the first wireless device and a second wireless device;
monitoring an interference level on the first link while operating in the first operation mode;
in response to the interference level exceeding a threshold, switching from the first operation mode to a second operation mode;
monitoring the plurality of wireless links while operating in the second operation mode;
while operating in the second operation mode, estimating a first performance metric for the first operation mode and a second performance metric for the second operation mode based on information collected from the plurality of wireless links; and
based on a comparison of the first performance metric and the second performance metric, determining whether to maintain the second operation mode or to switch to the first operation mode.

2. The method of claim 1, wherein the first operation mode is a multi-link single radio (MLSR) mode in which the first wireless device includes a plurality of radio-frequency (RF) chains sharing a shared resource, and performs data transmission and reception on only the first link using the plurality of RF chains on a same frequency band of the first link.

3. The method of claim 1, wherein the second operation mode is an enhanced multi-link single radio (EMLSR) mode in which the first wireless device includes a plurality of radio-frequency (RF) chains sharing a shared resource, and monitors at least the first link and a second link of the plurality of wireless links for transmission opportunities, and in response to detecting a transmission opportunity on a target link, switches the plurality of RF chains to the target link to perform data transmission and reception on a same frequency band of the target link.

4. The method of claim 1, wherein monitoring the interference level on the first link comprises:
measuring, over an observation period, a proportion of time during which the first link is occupied by interference relative to the observation period to obtain an interference ratio, wherein the interference ratio represents a reduction in available air time on the first link.

5. The method of claim 4, wherein the interference comprises at least one of: overlapping basic service set (OBSS) interference, Bluetooth interference, or noise.

6. The method of claim 1, wherein the first performance metric comprises an estimated throughput for the first operation mode, and the second performance metric comprises an estimated throughput for the second operation mode.

7. The method of claim 6, wherein the estimated throughput for the first operation mode is calculated as a product of an estimated physical layer data rate of the first link and an available air time ratio of the first link, the available air time ratio being one minus an interference ratio measured on the first link.

8. The method of claim 6, wherein the estimated throughput for the second operation mode is calculated by:
for each link of the plurality of wireless links, determining a per-link throughput contribution as a product of a link access probability, an estimated physical layer data rate, and an available air time ratio of the respective link, the available air time ratio being one minus an interference ratio measured on the respective link;
summing the per-link throughput contributions to obtain a combined throughput; and
applying a switching overhead factor to the combined throughput to obtain the estimated throughput for the second operation mode.

9. The method of claim 1, wherein an estimated physical layer data rate used for estimating at least one of the first performance metric or the second performance metric is determined based on a received signal strength indicator measured from beacon frames received on a respective link of the plurality of wireless links.

10. The method of claim 1, wherein determining whether to maintain the second operation mode or to switch to the first operation mode comprises:
switching to the first operation mode in response to the second performance metric being less than the first performance metric; and
maintaining the second operation mode in response to the second performance metric being greater than or equal to the first performance metric.

11. The method of claim 1, further comprising:
while maintaining the second operation mode, periodically re-estimating the first performance metric and the second performance metric based on updated interference information collected from the plurality of wireless links; and
re-determining whether to maintain the second operation mode or to switch to the first operation mode based on the re-estimated first performance metric and the re-estimated second performance metric.

12. A wireless device, comprising:
a plurality of antennas;
a transceiver coupled to the plurality of antennas and configured to communicate with a second wireless device over a plurality of wireless links;
one or more processors coupled to the transceiver; and
a memory coupled to the one or more processors and storing instructions that, when executed by the one or more processors, cause the wireless device to:
operate in a first operation mode on a first link of the plurality of wireless links;
monitor, via the transceiver, an interference level on the first link while operating in the first operation mode;
in response to the interference level exceeding a threshold, switch from the first operation mode to a second operation mode;
monitor, via the transceiver, the plurality of wireless links while operating in the second operation mode;
while operating in the second operation mode, estimate a first performance metric for the first operation mode and a second performance metric for the second operation mode based on information collected from the plurality of wireless links; and
based on a comparison of the first performance metric and the second performance metric, determine whether to maintain the second operation mode or to switch to the first operation mode.

13. The wireless device of claim 12, wherein the transceiver comprises a plurality of radio-frequency (RF) chains and a shared resource coupled to the plurality of RF chains, the shared resource constraining the plurality of RF chains to operate on a same frequency band;
wherein in the first operation mode, the wireless device performs data transmission and reception on only the first link via the plurality of RF chains operating on a same frequency band of the first link; and
wherein in the second operation mode, the wireless device monitors at least the first link and a second link of the plurality of wireless links for transmission opportunities, and dynamically switches the plurality of RF chains to a selected link of the plurality of wireless links to perform data transmission and reception on a same frequency band of the selected link.

14. The wireless device of claim 12, wherein the interference level is determined as an interference ratio measured over an observation period, the interference ratio representing a proportion of time during which the first link is occupied by interference, and wherein an available air time on the first link is reduced in proportion to the interference ratio.

15. The wireless device of claim 12, wherein the first performance metric and the second performance metric each comprise an estimated throughput, and wherein to calculate the estimated throughput for the second operation mode, the instructions cause the wireless device to:
for each link of the plurality of wireless links, determine a per-link throughput contribution as a product of a link access probability, an estimated physical layer data rate, and an available air time ratio of the respective link, the available air time ratio being one minus an interference ratio measured on the respective link;
sum the per-link throughput contributions to obtain a combined throughput; and
apply a switching overhead factor to the combined throughput to obtain the estimated throughput for the second operation mode.

16. The wireless device of claim 12, wherein the instructions further cause the wireless device to:
switch to the first operation mode in response to the second performance metric being less than the first performance metric; and
maintain the second operation mode in response to the second performance metric being greater than or equal to the first performance metric.

17. The wireless device of claim 12, wherein the instructions further cause the wireless device to:
while maintaining the second operation mode, periodically re-estimate the first performance metric and the second performance metric based on updated interference information collected from the plurality of wireless links; and
re-determine whether to maintain the second operation mode or to switch to the first operation mode based on the re-estimated first performance metric and the re-estimated second performance metric.

18. The wireless device of claim 12, wherein the interference level is measured based on at least one of: overlapping basic service set (OBSS) interference, Bluetooth interference, or noise.
